(19) United States
(12) Patent Application Publication
(10) Pub. No.: US 2006/0224677 A1
(43) Pub. Date: Oct. 5, 2006

(54) Method and apparatus for detecting email fraud

(75) Inventors: Mark M. Ishikawa, Los Gatos, CA (US); Dennis Willson, San Jose, CA (US); Travis Hill, Provo, UT (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: BayTSP, Los Gatos, CA (US)

(21) Appl. No.: 11/096,554

(22) Filed: Apr. 1, 2005

(51) Int. Cl. G06F 15/16

(52) U.S. Cl. 709/206

(57) ABSTRACT

A system and method for detecting email fraud is disclosed. In one embodiment of the invention, the system includes a collection module for collecting a plurality of bounced email messages originating from an injection source, and a source mining module for determining the location of the injection source. The bounced email messages include a fraudulent status indicator that can be detected to determine that the injection source is sending email messages intended to defraud the recipient users of the email. In another embodiment of the invention, the system for detecting email fraud includes a honeypot module for attracting email messages associated with an injection source, and a target module for determining the location of the target host, wherein the location of the target host is determined by examining the redirection mechanism. A monitoring system can be set up to monitor the status of the target host in order to determine whether the fraudulent web site on the target host is put back on the Internet, requiring additional corrective action.

### BACKGROUND

1. Field

Invention relates to Internet security and in particular to a method and apparatus for detecting email fraud.

2. Related Art

Internet users receive thousands of unwanted email messages every day. These messages are commonly known as spam. Spam is a waste of the system resources that are spent on its delivery to the user, and spam is also a waste of the human resources of the user who has to clean out the unwanted email from his email inbox. Spam is often harmless when it comes in the form of “junk mail” but more recently, the senders of spam (known as “spammers”) have begun to use spam for more insidious purposes such as fraud.

Fraud can be carried out through email in a number of ways. One form of email fraud is known as “phishing,” where email is used to lure victims to fraudulent web sites that appear to belong to legitimate companies. For example, a user might receive an email from a bank, where the email states that in order to keep their account from being closed, they need to provide some confidential information. This email will typically provide a link to what appears to be the bank's web site. However, the unscrupulous sender of the email has actually created this legitimate-looking link to connect to a fraudulent web site. The user, by clicking on the link that appears to be legitimately associated with the bank, is actually connected to a fraudulent web site that is set up to appear to be the bank's web site. From the fraudulent web site, the user is baited into entering confidential information. When the user fills out the online form on the fraudulent web site and submits it, for example by clicking on a “submit” button, the user's confidential information is then sent to the computer of the unscrupulous entity who posted the fraudulent web site on the Internet.

This email phishing technique provides a convenient way for an unscrupulous entity to carry out identity theft. At the same time, the user who is the victim of this scheme believes that his bank or other trusted entity has allowed his personal information to be leaked. This is a huge problem companies doing business online because their clients lose faith in the companies' ability to keep the clients' personal information private, and the companies also have to field complaints from customers regarding identity theft being carried out through web sites that appear to legitimately belong to the companies.

Existing techniques for combating email fraud concentrate on filtering out the unwanted email (spam) in order to prevent the user from reading the email message by redirecting it to a junk mail folder. By directing such email to a junk mail folder, the user assumes that the message is junk mail, does not open the message, and therefore never sees the link to the mock web site and never clicks on it. These email messages are filtered out from the rest of the user's email by using various rules for determining whether or not a message is spam or not.

These techniques provide a way for preventing email fraud by attempting to divert dangerous emails away from the user's attention. However, these filtering techniques do not provide a means for tracking down the sources of the problem, namely the sender of the spam email and the web host on which the fraudulent web site appears. What is needed is a way to track down the sources of the problem in order to stop them from operating and defrauding additional users.

### SUMMARY

A system and method for detecting email fraud is disclosed. The method includes collecting an email message originating from an injection source, wherein the email message includes an indicator associated with a legitimate web site. The legitimate web site is owned by a legitimate organization such as a bank, a credit card company, or a company that sells appropriately priced products under a valid intellectual property license. A redirection mechanism associated with the legitimage web site indicator provides for redirection from the legitimate web site to a fraudulent web site. The fraudulent web site is located on a target host having a location that is determined and reported to the owner of the legitimate web site. Alternatively, the target web site can be reported to the Internet Service provider (ISP) providing web hosting services to the target web site in order to put the ISP on notice of the fraudulent user of the target web site.

In one embodiment of the invention, the system includes a collection module for collecting a plurality of bounced email messages originating from an injection source, and a source mining module for determining the location of the injection source. The bounced email messages include a fraudulent status indicator that can be detected to determine that the injection source is sending email messages intended to defraud the recipient users of the email. The fraudulent status indicator can be text, for example, a keyword or a text message indicating an intent to infringe intellectual property rights. Alternatively, the fraudulent status indicator can be included in the contents of an image. The contents of the image can be determined through the use of a checksum such as the MD5 algorithm or a CRC check. Any suitable checksum algorithm known in the industry or developed in the future can be used for this purpose.

In another embodiment of the invention, the system for detecting email fraud includes a honeypot module for attracting email messages associated with an injection source, and a target module for determining the location of the target host, wherein the location of the target host is determined by examining the redirection mechanism. The method includes attracting the email messages including the redirection mechanism for directing a user to a target host associated with a fraudulent web site, and then determining the location of the target host so that the legitimate web site owner can be alerted of the problem or so that the target host can be shut down, thus preventing future email fraud. A monitoring system can be set up to monitor the status of the target host in order to determine whether the fraudulent web site on the target host is put back on the Internet, requiring additional corrective action.

### BRIEF DESCRIPTION OF THE DRAWINGS

FIG. 1 is a block diagram showing an example of email fraud in an Internet environment.

FIG. 2 is a flow diagram showing an example of how email fraud can be carried out.

FIG. 3 is a block diagram showing a system for detecting email fraud in accordance with embodiments of the present invention.

FIG. 4 is a flow diagram showing a method for detecting email fraud in accordance with an embodiment of the present invention.

FIG. 5 is a flow diagram showing a method for determining whether a detected image matches the fingerprint of an image that is known to be from a target source.

### DETAILED DESCRIPTION

The following serves as a glossary of terms as used herein:

Email Phishing—pronounced “fishing,” email phishing is the practice of sending fraudulent emails appearing to be from a legitimate source in order to bait unsuspecting email recipients into surrendering confidential information, typically to carry out identity theft.

Honeypot—a honeypot is a device having known vulnerabilities that is deliberately exposed to a public network for the purpose of collecting information about attackers' behavior and also for drawing attention away from other potential targets.

Sender Policy Network (SPF)—SPF makes it easy for a domain, whether it is an ISP, a business, a school, or a vanity domain, to say, “I only send mail from these machines. If any other machine claims that I am sending mail from there, they are lying.” For more information, see http://spf.pobox.howworks.html.

Spam—Unsolicited “junk” e-mail sent to large numbers of people to promote products or services.

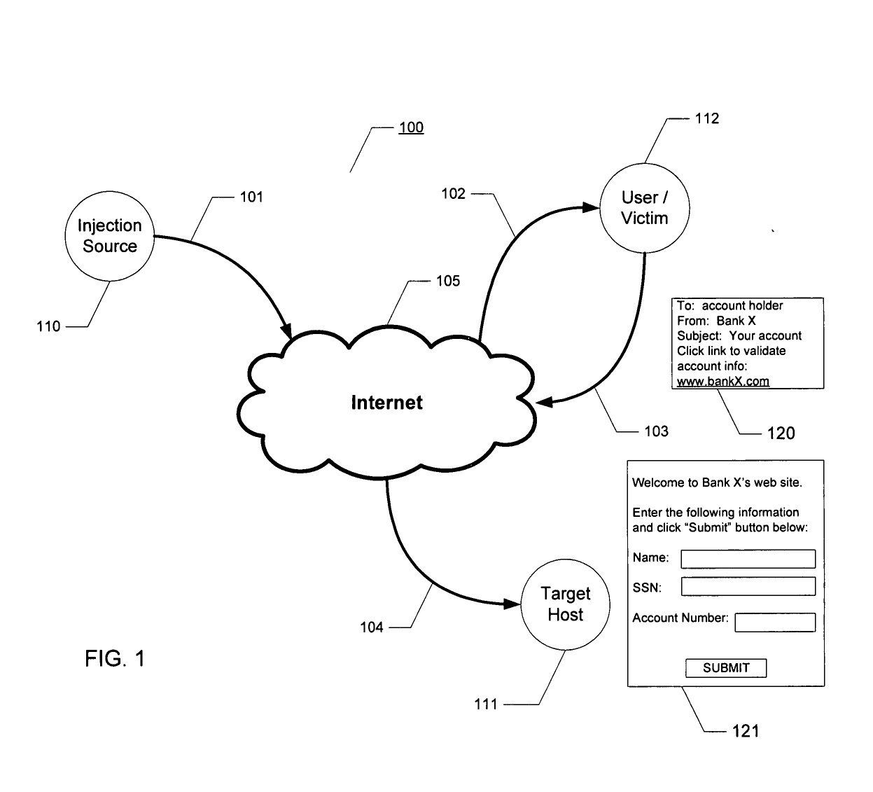

Spoofing—A technique used to gain unauthorized access to computers, whereby the intruder sends messages to a computer with an IP address indicating that the message is coming from a trusted host. To engage in IP spoofing, a hacker must first use a variety of techniques to find an IP address of a trusted host and then modify the packet headers so that it appears that the packets are coming from that host. FIG. 1 is a block diagram 100 showing an example of email fraud in an Internet environment. An injection source 110 sends a plurality of email messages over the Internet 105, as shown by arrow 101. These unsolicited and unwanted email messages are often referred to as spam. The injection source 110 is typically an unscrupulous entity on the Internet who is sending emails that contain text or images that are useful for attracting a user to the follow a web link contained in the email. A user or prospective fraud victim 112 receives the email, as shown by arrow 102, from the injection source 110 through the Internet 105. The email sent to the user typically looks like message 120. A user might be sent an email that appears to come from his bank, telling him that his bank account needs to be validated. In this case, the injection source has “spoofed” the “from” address of the bank in order to fool the receiver into believing that the message actually came from the bank. The email message 120 will also provide a link to what appears to be a legitimate web site, that is, the bank's web site. The user clicks on the link, shown by arrow 103, and is redirected to a target host 111, as shown by arrow 104.

When the user is redirected to a web site associated with a target host 111, where the user sees a form 121 which contains questions inquiring various confidential information belonging to the user. An unsuspecting user, believing that this web site is legitimate and belongs to their bank, fills out the firm and clicks on the “submit” button shown on form 121. Upon clicking on “submit,” the user sends his confidential information to the target host, not realizing that the target host is fraudulent and not associated with the legitimate organization. This is referred to as email “phishing” as noted in the glossary above, and is an effective way to carry out identity theft.

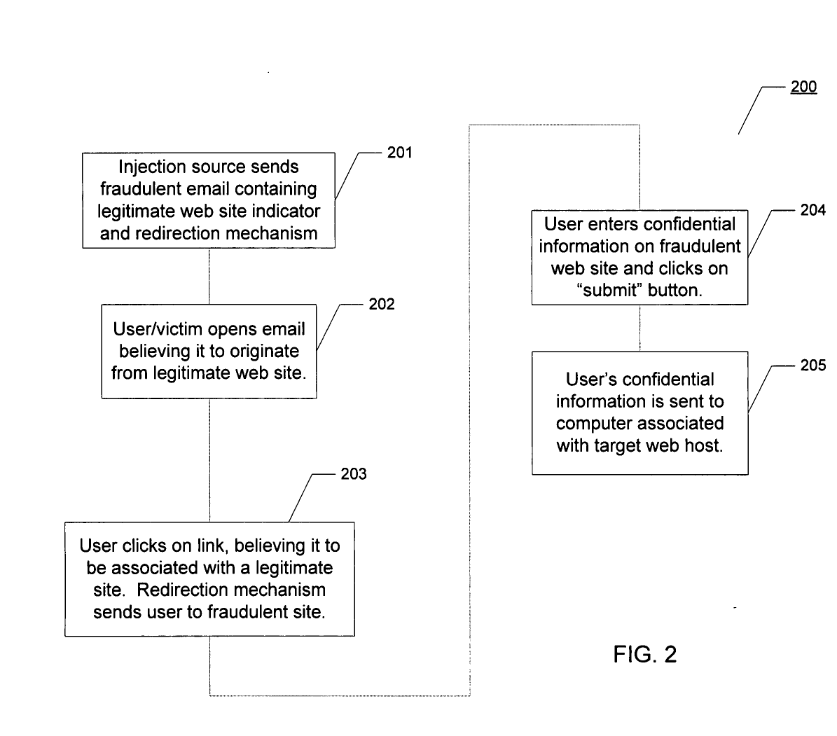

FIG. 2 is a flow diagram 200 showing an example of how email fraud can be carried out. In step 201, the injection source sends a plurality of fraudulent email messages containing an indicator that looks like it is pointing to a legitimate web site. The messages also contain a redirection mechanism that is invoked for the purpose of directing the user to a fraudulent web site in response to their selecting the legitimate web site indicator. In step 202, the user opens the email message and is fooled into believing that the email has originated from a legitimate web site owner. In step 203, the user clicks on the link to what the user believes is a legitimate web site, and instead, the user is redirected to a fraudulent web site. The fraudulent web site is set up to look like a legitimate web site, and the user is fooled into entering confidential information on the fraudulent web site, as shown in step 204. In step 205, the user's confidential information is sent to a computer associated with the target web host as a result of the user submitting his information in step 204. At this point the fraud, or the “phish” is completed and the unscrupulous owner of the target web site has obtained the user's confidential information.

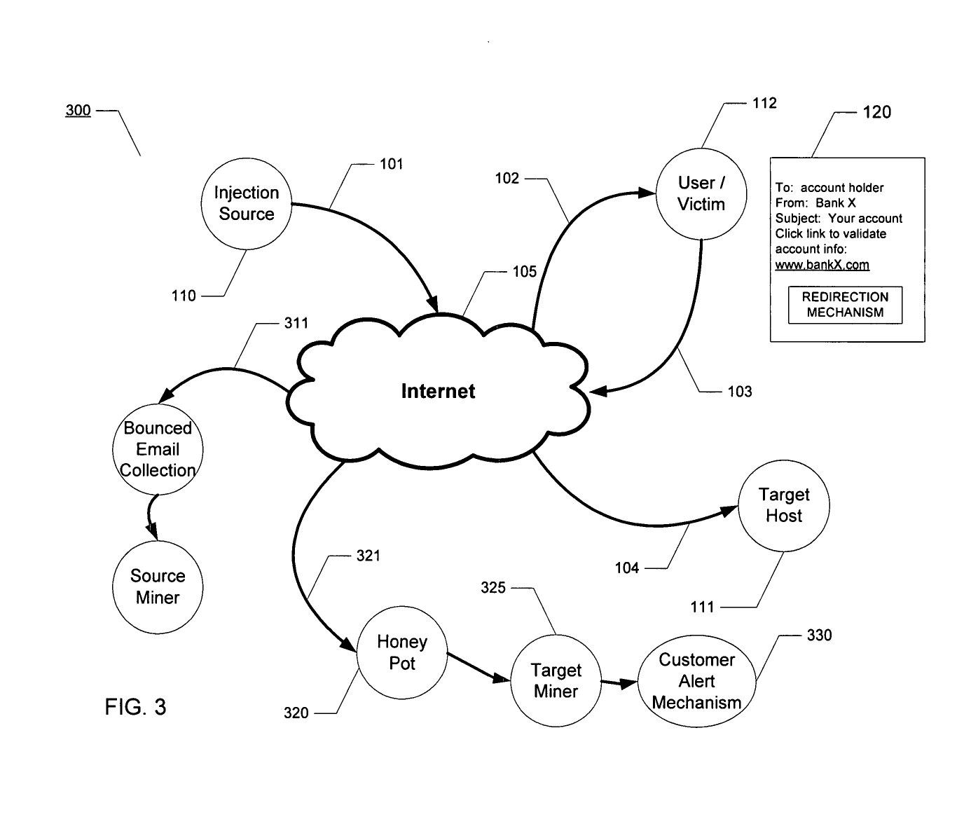

FIG. 3 is a block diagram 300 showing a system for detecting email fraud in accordance with embodiments of the present invention. A collection module 310 receives bounced email messages from the Internet 105. The bounced email messages are collected and the data contained in them is analyzed using a source mining module 315.

The source mining module 315 determines which email messages come from a fraudulent source such as the injection source 110. The source mining module 315 can also be used to determine the location of the injection source 110 based on information obtained in the bounced email messages.

The data contained in the email messages includes a fraudulent status indicator. The fraudulent status indicator can be a text message associated with a fraudulent purpose. For example, if the text “buy this $1000 software package for $50” appears in the email, there is a high probability that the sender of the email intended to defraud the recipient of the email into either providing credit card information to obtain the software, and/or to violate the intellectual property rights of the sell of the software package. The fraudulent status indicator can also be a link to what appears to be a legitimate web site, for example a web site associated with a bank.

Instead of text, the injection source 110 can inject email messages containing images that contain a fraudulent status indicator. By using images, the sender of the email messages hopes to avoid detection through text searches implemented by the source miner 315. A checksum can be performed on the image contained in the email message to determine its contents and to detect the fraudulent status indicator. This checksum can be performed by using algorithms such as the MD5 and the CRC algorithm.

A honeypot 320 can be created to attract email messages associated with injection source 110, wherein the email message includes a redirection mechanism 340 for directing the user 112 to a target host 111 associated with a fraudulent web site 121. The email messages include a “to” address, a “from” address and an email body. The “from” address of the email messages can be inspected prior to accepting the email body, in order to filter out messages that would not be useful to include in the honeypot. These email messages are accepted or dropped from the honeypot based on accept/drop criteria. For example, email messages that can be verified as being legitimately sent from a particular legitimate domain can be dropped from the honeypot prior to accepting the email body. One method for differentiating real messages from messages that are sent from a fraudulent domain is by using SPF records in DNS. SPF allows a domain, whether an ISP, a business, a school or a vanity domain, to indicate that it only sends email from specific machines, and that if any other machine claims to be sending mail with their “from” address, then the email is fraudulent. (See http://spf.pobox.com/howworks.html for more information.)

A target mining module 325 coupled to the honeypot 320 takes the collected information and determines the location of the target host 111. A customer alert mechanism 330 can also be coupled to the target miner 325 or the honeypot 320 in order to alert the owner of the legitimate web site of the fraud in progress. Alternatively, an alert mechanism targeted at the Internet service provider (ISP) that is responsible for the target host 111 can also be activated upon determination of the location of the target host 111.

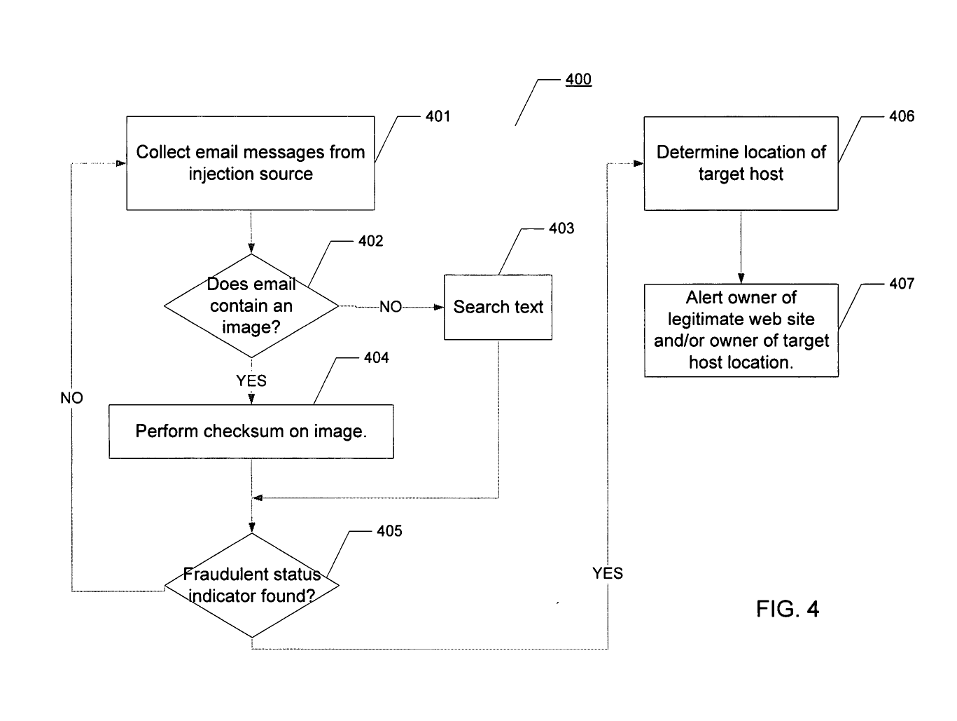

FIG. 4 is a flow diagram 400 showing a method for detecting email fraud in accordance with an embodiment of the present invention. Email messages are collected from the injection source, step 401. The email message is checked for images, step 402, and if the email message does not contain an image then a text search is performed, step 403. If the email message contains an image, then a checksum is performed on the image, step 404. The checksum can be performed using algorithms such as MD5 or CRC. If the message appears to be fraudulent, step 405, in other words, if a fraudulent status indicator is found, then the location of the target host is determined, step 406. Upon determining the location of the target host, further action is taken to alert interested parties, step 407. For example, the owner of the legitimate web site can be alerted to the fraudulent activity. In addition, the owner or ISP associated with the target host location can also be contacted and required to remove the offending fraudulent web site from the Internet. A monitoring feature can also be added to provide periodic checking to make sure that the offending fraudulent web site is not put back on the Internet.

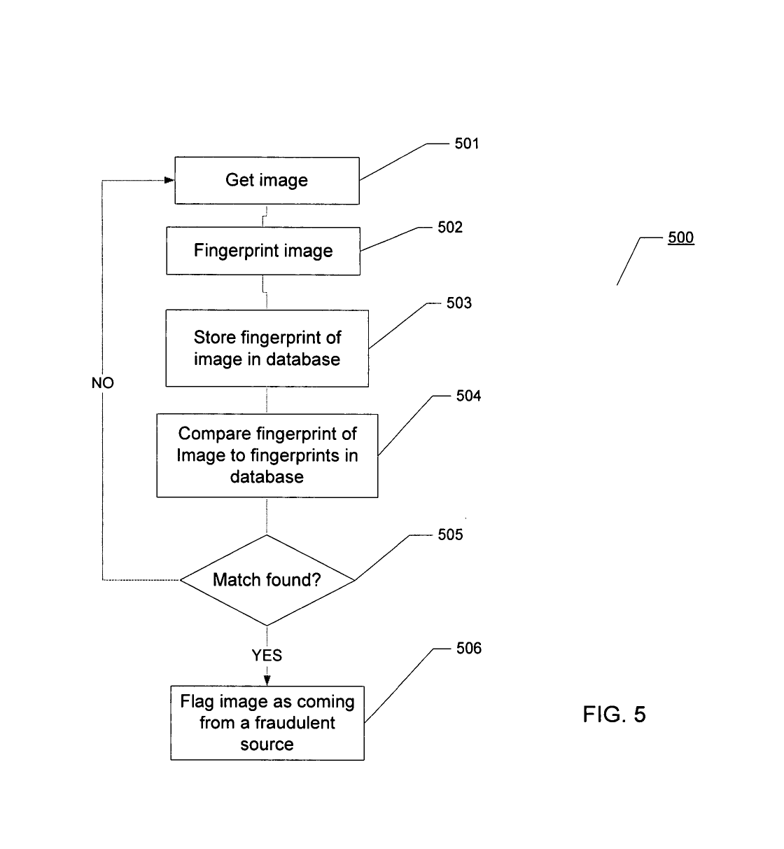

FIG. 5 is a flow diagram 500 showing a method for determining whether a detected image matches the fingerprint of an image that is known to be from a target source such as a sender of fraudulent email. As discussed above, fraudulent email messages can contain images that are used to escape detection by text searches that are implemented by devices such as the source miner 351. An indexable database is built up of the fingerprints of images that contain indicators that the email comes from a fraudulent source. When building the database of fingerprints, the fingerprints of a plurality of images are created. An image that is found to contain an indication that is fraudulent, typically done through a visual inspection, if fingerprinted and the image's fingerprint is stored in the indexable database. Such images include, for example, an image that shows a text string such as “buy cheap software”, the name of a well-known bank, or any other indicator that the message could be from a fraudulent source. Since this text is made up of the pixels contained in the image, a text search will not detect it.

An image is detected, step 501, in an email message. This image is then fingerprinted, step 502, in order to be able to store the fingerprint of the image in the database, and to use that fingerprint for detecting images that have the same fingerprint. One reason for using fingerprints rather than comparing each pixel in the images being compared is that comparing fingerprints is more efficient. In one embodiment of the invention, the fingerprinting is accomplished in accordance with processes such as that described in U.S. patent application Ser. No. 09/670,242 entitled, “Method, Apparatus, and System for Managing, Reviewing, Comparing and Detecting Data on a Wide Area Network,” which is herein incorporated by reference. The fingerprint of the image can be stored in an indexable database, step 503. A plurality of such fingerprints on images are stored and used for comparison against the fingerprints of images contained in email messages that are collected in the honeypot. When email messages containing matching images are found, they can be flagged as being fraudulent. Once flagged, the source of the message can be determined in order to trace the sender of the message.

After the image is fingerprinted, step 502, the fingerprinting is stored in a database, step 503. This fingerprint is used for comparison to the fingerprints of other images contained in the database, step 504. If a match is found, step 505, then the email message is identified as coming from a fraudulent source, step 506.

The foregoing described embodiments of the invention are provided as illustrations and descriptions. They are not intended to limit the invention to the precise form described. In particular, it is contemplated that functional implementations of the invention described herein may be implemented equivalently in hardware, software, firmware, and/or other available functional components or building blocks, and that networks may be wired, wireless, or a combination of wired and wireless. Other variations and embodiments are possible in light of the above teachings. This, it is intended that the scope of invention is not limited by this Detailed Description, but rather by the following Claims.

We claim:

1. A method for detecting email fraud, comprising the steps of:
collecting an email message originating from an injection source, wherein the email message includes:
an indicator associated with a legitimate web site having an owner;
a redirection mechanism associated with the indicator, said redirection mechanism providing for redirection from the legitimate web site to a fraudulent web site, wherein the fraudulent web site is located on a target host having a location; and
determining the location of the target host associated with the fraudulent web site.

2. The method of claim 1, wherein the redirection mechanism is a URL.

3. The method of claim 1, wherein the redirection mechanism is implemented using a script that is embedded in the email message.

4. The method of claim 1, wherein the redirection mechanism is an auto launcher.

5. The method of claim 1, wherein the redirection mechanism is implemented using Active X controls.

6. The method of claim 3, wherein the script is Javascript.

7. The method of claim 1, further comprising the step of:
alerting the owner of the legitimate web site.

8. A method for detecting email phishing, comprising:
collecting an email message from an email injection source having a location, wherein the email message includes:
an indicator associated with a legitimate web site having an owner; and
a redirection mechanism, said redirection mechanism providing for redirection to a fraudulent web site, wherein the fraudulent web site is located on a target web host; and
determining the location of the email injection source.

9. A method for detecting email phishing, comprising the steps of:
collecting an email message originating from an injection source, wherein the email message includes:
an indicator associated with a legitimate web site;
a redirection mechanism, said redirection mechanism providing for redirection to a fraudulent web site, wherein the fraudulent web site is located on a target web host having a location; and
determining the location of the target web host associated with the fraudulent web site.

10. The method of claim 9, wherein the redirection mechanism is a URL.

11. The method of claim 9, wherein the redirection mechanism is implemented using a script that is embedded in the email message.

12. The method of claim 9, wherein the redirection mechanism is an auto launcher.

13. The method of claim 9, wherein the redirection mechanism is implemented using Active X controls.

14. The method of claim 11, wherein the script is Javascript.

15. The method of claim 9, further comprising the step of:
alerting the owner of the legitimate web site.

16. A system for detecting email fraud, comprising:
a collection module for collecting a plurality of bounced email messages originating from an injection source; and
a source mining module for determining the location of the injection source.

17. A method for detecting email fraud, comprising:
collecting a plurality of spam email messages originating from an injection source having a location, wherein the spam email messages include a fraudulent status indicator; and
determining the location of the injection source.

18. The method of claim 17, wherein the fraudulent status indicator is a keyword.

19. The method of claim 17, wherein the fraudulent status indicator is a text message indicating an intent to infringe intellectual property rights.

20. The method of claim 17, wherein the spam email message includes an image, and further comprising the steps of:
performing a checksum on the image in order to determine the contents of the image, wherein the contents of the image include the fraudulent status indicator.

21. The method of claim 20, wherein the checksum is performed using the MD5 algorithm.

22. The method of claim 21, wherein the checksum is performed using a CRC algorithm.

23. A system for detecting email fraud, comprising:
a honeypot module for attracting an email message associated with an injection source, wherein the email message includes a redirection mechanism for directing a user to a target host associated with a fraudulent web site, wherein the target host has a location associated with the redirection mechanism; and
a target mining module for determining the location of the target host.

24. A method for detecting email fraud, comprising:
attracting an email message associated with an injection source, wherein the email message includes a redirection mechanism for directing a user to a target host associated with a fraudulent web site, wherein the target host has a location associated with the redirection mechanism; and
determining the location of the target host.
